(19) United States
(12) Patent Application Publication
(10) Pub. No.: US 2005/0120024 A1
(43) Pub. Date: Jun. 2, 2005

(54) Systems, methods, and computer program products for tracking and controlling Internet use and recovering costs associated therewith

(76) Inventors: James Benjamin Tharpe JR., Marietta, GA (US); Matthew J. McInerny, Marietta, GA (US); Michael Lewis Williams, Roswell, GA (US)

Correspondence Address: SUTHERLAND ASBILL & BRENNAN LLP, 999 PEACHTREE STREET, N.E., ATLANTA, GA, 30309, US

(21) Appl. No.: 10/948,475

(22) Filed: Sep. 23, 2004

Related U.S. Application Data
(60) Provisional application No. 60/506,288, filed on Sep. 26, 2003.

(51) Int. Cl. G06F 7/00

(52) U.S. Cl. 707/10

(57) ABSTRACT

Systems, methods and computer program products enable the recovery of costs associated with Internet browsing by requiring the users to enter validation information such as a client and matter number before accessing administrator-identified web sites. Administrators may also control Internet browsing using executable scripts that operate when administrator-specified filters are satisfied. These scripts may log all or select Internet activity, prevent a browser from accessing a URL, redirect a browser, save HTML or web page content, and generally control all Internet browser use for web browsing.

### RELATED APPLICATION DATA

The present application claims the benefit of U.S. Provisional Patent Application Ser. No. 60/506,288, filed Sep. 26, 2003, titled “Just-in-Time Validation and Logging of Fee-Based Online Services”, which is hereby incorporated by reference as if set forth fully herein.

### FIELD OF THE INVENTION

The present invention relates generally to software applications for tracking Internet browsing, and more specifically, to systems, methods and computer program products that enable the logging and control of a user's Internet browsing activity.

### BACKGROUND OF THE INVENTION

Accessing content via the Internet can be a time consuming affair, whether conducted for personal reasons or to retrieve information for employment purposes. Often this is due to the wealth of information available on countless Internet web pages, which may be accessed using a variety of methods and search tools. Tracking the amount of time spent in this manner may not be important where a user is “surfing” the internet for personal reasons at home. However, tracking the time spent by someone at work may be important to maintain a historical record of a browsing session and/or to identify what an employee is doing. In service based businesses tracking Internet access time may also be important in order to recover costs associated with Internet use. It would be useful for these costs to be attributed to a particular client or matter such that the service-based business can pass the costs directly onto a particular client. For instance, where an attorney is conducting Internet legal research, it would be helpful to allow the attorney to specify a client or matter corresponding to the research. This may be particularly important where a user accesses a web site that requires payment for access.

Although many Internet browsers include functions to allow the tracking or even control of a user's internet activity, they do not permit the recovery of costs associated with Internet access because they do not permit a user to associate a client name or the like with an internet session. They also typically track all pages accessed by an Internet browser rather than only that time spent at web sites identified by the user or an administrator as significant, such as those pay web sites related to research or other employment purposes.

Therefore, what is needed is a method for enabling the recovery of electronic research costs incurred via Internet use, where the costs may be associated with a particular client, matter, or the like. It would also be advantageous if the recovery of such costs occurred only for those web sites identified by a user or administrator as significant.

### SUMMARY OF THE INVENTION

Systems, methods and computer program products of the present invention enable the tracking and recovery of electronic research costs and usage through a web browser by allowing the tagging of specified Internet web sites for tracking and billing purposes. The present invention collects detailed information about who has been to which web sites, including how long they were there. This browsing information can be viewed by administrators. This allows companies that conduct research, such as law firms, to recover costs associated with browser-based online research web sites. The invention transforms a resource center into a profit center by enabling users to accurately monitor online research usage, bill back research time and recoup electronic research costs. In addition, this invention saves non-billable staff time, as librarians no longer have to match research sessions to client/matter numbers and accounting staff can easily import the captured data into time and billing systems.

From the user's point of view, tracking begins automatically whenever designated research web sites or specific areas of designated research web sites are visited. Users simply choose a valid client, matter, and timekeeper ID from a validation screen, and research information will be accurately tracked and recorded. The validation screen may be automatically provided to the user upon the user's attempt to access an administrator-identified web site. Furthermore, using filters and executable scripts of the present invention, administrators may control the user's use of an Internet browser to access web sites such as pay sites. This invention saves administrators' valuable time trying to match session times with applicable clients or matters. It also provides useful information about how research resources are being used and applied. Furthermore, it delivers accurate billing information that allows the customer to pass research-related costs to clients.

According to one embodiment of the present invention, there is disclosed a method for controlling an Internet browser. The method includes the steps of: storing at least one filter, wherein the at least one filter corresponds to one or more Internet web addresses; identifying a uniform resource locator (URL) requested by the Internet browser; comparing the requested URL to the at least one filter to determine whether the requested URL matches the one or more Internet web addresses; and executing a script when the requested URL matches the one or more Internet web addresses corresponding to the at least one filter.

According to one embodiment of the invention, the step of executing a script further includes the step of executing a user-defined script associated with the at least one filter. The method may also include the step of presenting a script edit interface to a user, where the script edit interface is operable to enable a user to define the user-defined script. According to another aspect of the invention, the method may also include the step of receiving a user-defined executable instruction via the script edit interface. Additionally, the step of presenting the script interface may include presenting the script interface to a user only if the user has administrative rights.

According to another aspect of the invention, the method includes the step of presenting at least one filter edit interface to the user, where the filter edit interface is operable to receive the at least one filter from the user. The method may also include the step of receiving the at least one filter from the user only if the user has administrative rights. Furthermore, the step of executing the script may also include the step of preventing the Internet browser from navigating to the web site having the URL requested by the Internet browser. According to yet another aspect of the invention, the step of executing the script further includes the step of requesting validation information from a user prior to permitting the Internet browser from navigating to the web site having the URL requested by the Internet browser.

The step of requesting validation information from a user may include requesting validation information using a user ID, a client number, a client name, a matter name, and/or a matter number. The user may also be presented with a validation interface, where the validation interface is operable to receive validation information input by a user. Moreover, the method may also include the step of displaying validation information stored in a time entry program. According to another aspect of the invention, the method also includes the step of logging the requested URLs that match the one or more Internet web addresses corresponding to the at least one filter.

According to yet another aspect of the invention, a current uniform resource locator (URL) currently displayed by the Internet browser is identified. The current URL may be compared to the at least one filter to determine whether the current URL matches the one or more Internet web addresses. The method may also execute a script when the current URL matches the one or more Internet web addresses. According to yet another aspect of the invention, the step of executing the script when the current URL matches the one or more Internet web addresses occurs prior to executing a script when the requested URL matches the one or more Internet web addresses corresponding to the at least one filter.

According to another embodiment of the invention, there is disclosed a method for controlling an Internet browser. The method includes storing at least one filter, where the at least one filter corresponds to one or more predefined Internet web addresses, and identifying the uniform resource locator (URL) for the Internet web page currently displayed by Internet browser. The method also includes comparing the URL to the at least one filter to determine whether the URL matches the one or more predefined Internet web addresses, and executing a script when the URL matches the one or more predefined Internet web addresses corresponding to the at least one filter.

According to one aspect of the invention, the step of executing a script further includes the step of executing a user-defined script associated with the at least one filter. The method may also include the step of presenting a script edit interface to a user, where the script edit interface is operable to enable a user to define the user-defined script. The script interface may also enable a user to input a user-defined executable instruction implemented by the script. According to one aspect of the invention, the script interface may only be accessed if the user has administrative rights. According to another aspect of the invention, the method also includes the step of presenting at least one filter edit interface to the user, where the filter edit interface is operable to receive the at least one filter from the user. Like the script edit interface, the step of receiving the at least one filter from the user may occur only if the user has administrative rights.

According to yet another aspect of the invention, the step of executing the script further includes the step of preventing the Internet browser from navigating to a user-requested web site. The script may also or alternatively request validation information from a user prior to permitting the Internet browser from navigating to a user-requested web site. Furthermore, according to one aspect of the invention, the step of requesting validation information from a user includes requesting validation information that is selected from the group of information consisting of a user ID, a client number, a client name, a matter name, and a matter number.

The method may also include the step of presenting the user a validation interface, wherein the validation interface is operable to receive validation information input by a user. Validation information stored in a time entry program may also be displayed. According to another aspect of the invention, the method may also include the step of identifying a requested URL requested by the Internet browser. Where a requested URL is identified, the method may include the step of comparing the requested URL to the at least one filter to determine whether the requested URL matches the one or more Internet web addresses. Additionally, a script may be executed when the requested URL matches the one or more Internet web addresses.

According to yet another embodiment of the invention, there is disclosed a system for controlling Internet browsing. The system includes a computer having an Internet browser operable to display an Internet web site and to receive a user request to navigate to a requested uniform resource locator (URL). The system also includes a lookup precision module in communication with the computer, where the lookup precision module is operable to: identify the requested URL; compare the requested URL to at least one filter to determine whether the requested URL matches one or more Internet web addresses corresponding to the at least one filter; and execute a script when the requested URL matches the one or more Internet web addresses corresponding to the at least one filter.

According to one aspect of the invention, the lookup precision module is local to the computer. However, at least a portion of the lookup precision module may also be remote from the computer. According to another aspect of the invention, the system may also include a script edit interface in communication with the lookup precision module, where the script edit interface allows an administrator to define the script. The script edit interface may be operable to receive a user-defined executable instruction. According to yet another aspect of the invention, the script may contain a URL redirection instruction such that the Internet browser will navigate to a new URL instead of the requested URL. The script may also or alternatively contain a validation request instruction such that the user will be requested to input validation information prior to the Internet browser navigating to the requested URL.

According to another aspect of the invention, the system may include a validation module in communication with the lookup precision module, where the validation module is operable to validate validation information input by the user. The validation module may be in communication with a time entry program and/or a billing system. The system may also include a filter edit interface, where the filter edit interface is operable to receive the at least one filter from the user. Additionally, the system may include at least one database in communication with the lookup precision module, where the database is operable to store historical browsing activity of the Internet browser.

According to another embodiment of the invention, there is disclosed a computer-readable medium storing computer-executable instructions for performing the steps of: identifying a uniform resource locator (URL) requested by an Internet browser; comparing the requested URL to at least one filter identifying at least one Internet address to determine whether the requested URL matches the at least one Internet address; and executing a script when the requested URL matches the one or more Internet web addresses corresponding to the at least one filter.

According to one aspect of the invention, the computer-readable medium further stores computer-executable instructions for presenting a script edit interface to a user, where the script edit interface is operable to enable a user to define the user-defined script. The computer-readable medium may also store computer-executable instructions for receiving a user-defined executable instruction via the script edit interface, and/or for presenting the script interface to a user only if the user has administrative rights.

According to another aspect of the invention, the computer-readable medium may further store computer-executable instructions for presenting at least one filter edit interface to the user, where the filter edit interface is operable to receive the at least one filter from the user. Computer-executable instructions may also prevent the Internet browser from navigating to a web site having the URL requested by the Internet browser. Additionally, the computer-readable medium may include computer-executable instructions for requesting validation information from a user prior to permitting the Internet browser from navigating to a web site having the URL requested by the Internet browser. Requested validation information may include information such as a user ID, a client number, a client name, a matter name, and/or a matter number.

According to yet another aspect of the invention, the computer-readable medium may further store computer-executable instructions for accessing validation information stored in a time entry program or in a billing system. The computer-readable medium may also store computer-executable instructions for identifying a current URL currently displayed by the Internet browser, and/or for comparing the current URL to the at least one filter to determine whether the current URL matches the at least one Internet addresses. The computer-readable medium can also store computer-executable instructions for executing a second script when the current URL matches the one or more Internet web addresses.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating an exemplary system for implementing the invention, according to one embodiment of the present invention.

FIG. 2 is a block diagram illustrating an exemplary system of the present invention, according to one embodiment of the present invention.

FIG. 3 is a block diagram showing the communication between computer components in enabling Internet browser tracking, monitoring and control, according to one embodiment of the present invention.

FIG. 4A shows an illustrative example of a validation GUI, according to one embodiment of the present invention.

FIG. 4B shows an illustrative example of a validation lookup window accessed from the validation GUI of FIG. 4A, according to one embodiment of the present invention.

FIG. 5 is a block diagram showing components of a validation database and logging server, according to one embodiment of the present invention.

FIG. 6 shows an illustrative example of a log interface illustrating logged web site data, according to one embodiment of the present invention.

FIG. 7 shows a high level process flow diagram illustrating the processing of filters and scripts, according to one embodiment of the present invention.

FIG. 8 is a block diagram flow chart illustrating the processing of filters for a URL, according to one embodiment of the present invention

FIG. 9 is a block diagram flow chart illustrating the processing of an individual filter, according to one embodiment of the present invention.

FIG. 10 shows an illustrative filter editor, according to one embodiment of the invention.

FIG. 11 shows an illustrative detail edit interface, according to one embodiment of the present invention.

FIG. 12 shows a block diagram flow chart showing the implementation of an illustrative script, according to one aspect of the invention.

FIG. 13 shows an illustrative web browser having a LookUp Precision toolbar, according to one embodiment of the present invention.

FIG. 14 shows an illustrative LookUp Precision toolbar, according to one embodiment of the present invention.

FIG. 15 shows a browser activity log, according to an illustrative embodiment of the present invention.

FIG. 16 shows an options interface, according to an illustrative embodiment of the present invention.

FIG. 17 shows an illustrative administrative interface, according to one embodiment of the present invention.

### DETAILED DESCRIPTION OF THE INVENTION

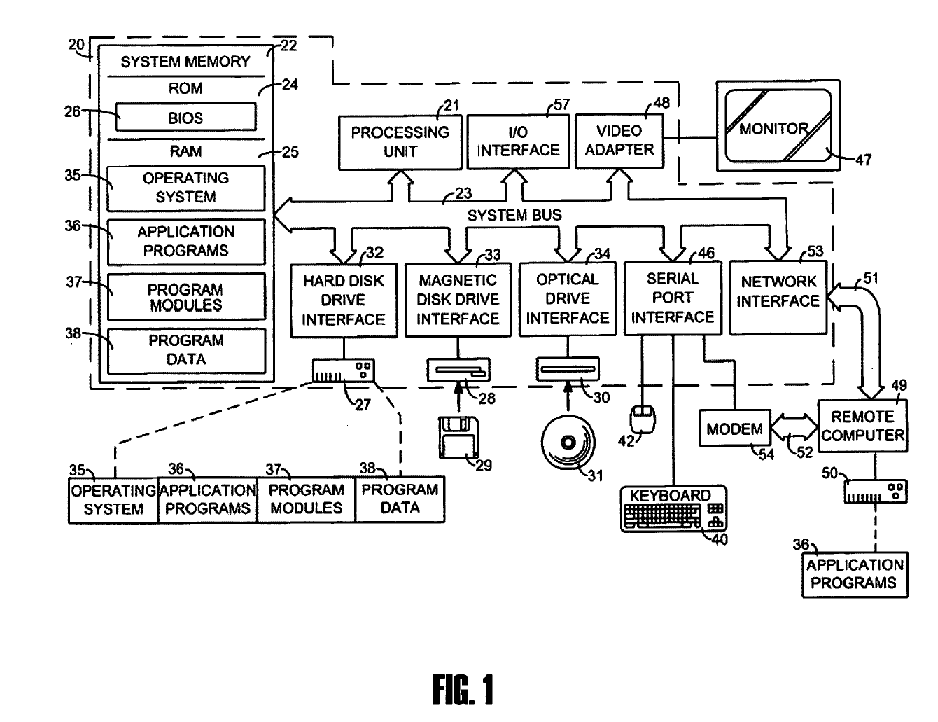

FIG. 1 and the following discussion are intended to provide a brief, general description of a suitable computing environment in which the invention may be implemented. Although not required, the invention will be described in the general context of computer-executable instructions, such as program modules, being executed by one or more computers. Generally, program modules include routines, programs, objects, components, data structures, etc. that perform particular tasks or implement particular abstract data types. Moreover, those skilled in the art will appreciate that the invention may be practiced with other computer system configurations, including a client-server system, multiprocessor systems, microprocessor-based or programmable consumer electronics, network PCs, minicomputers, mainframe computers, and the like. The invention may also be practiced in distributed computing environments where tasks are performed by diverse and/or remote processing devices that are linked through a communications network such as a local area network (LAN), wide area network (WAN), or the Internet.

With reference to FIG. 1, an exemplary system for implementing the invention includes a general purpose computing device in the form of a conventional computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routine that helps to transfer information between elements within the personal computer 20, such as during start-up, is stored in ROM 24.

The personal computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage of computer readable instructions, data structures, program modules and other data for the computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, CDs, DVDs, random access memories (RAMs), read only memories (ROMs), and the like, may also be used in the exemplary operating environment.

A number of program modules may be stored on the hard disk, magnetic disk 29, optical disk 31, ROM 24 or RAM 25, including an operating system 35, one or more application programs 36, other program modules 37, and program data 38. A user may enter commands and information into the personal computer 20 through input devices such as a keyboard 40 and pointing device 42 (such as a mouse). An I/O interface 57 is connected to the system bus 23, thereby allowing input data to be routed to and stored in the RAM 25, or one of the other data storage devices associated with the computer 20. The data can be input into the computer 20 from any of the aforementioned computer-readable media, as well as other input devices (not shown) which may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as a remote computer 49. The remote computer 49 may be a computer, a server, a router, a network PC, a peer device or other common network node, and typically includes many or all of the elements described above relative to the computer 20. The logical connections depicted in FIG. 1 include a local area network (LAN) 51 and a wide area network (WAN) 52. Such networking environments are commonplace in offices, enterprise-wide computer networks, Intranets and the Internet. When used in a LAN networking environment, the computer 20 is connected to the local network 51 through a network interface or adapter 53. When used in a WAN networking environment, the computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used. The computer 20 may be used as a server computer or client computer for implementing the invention described below.

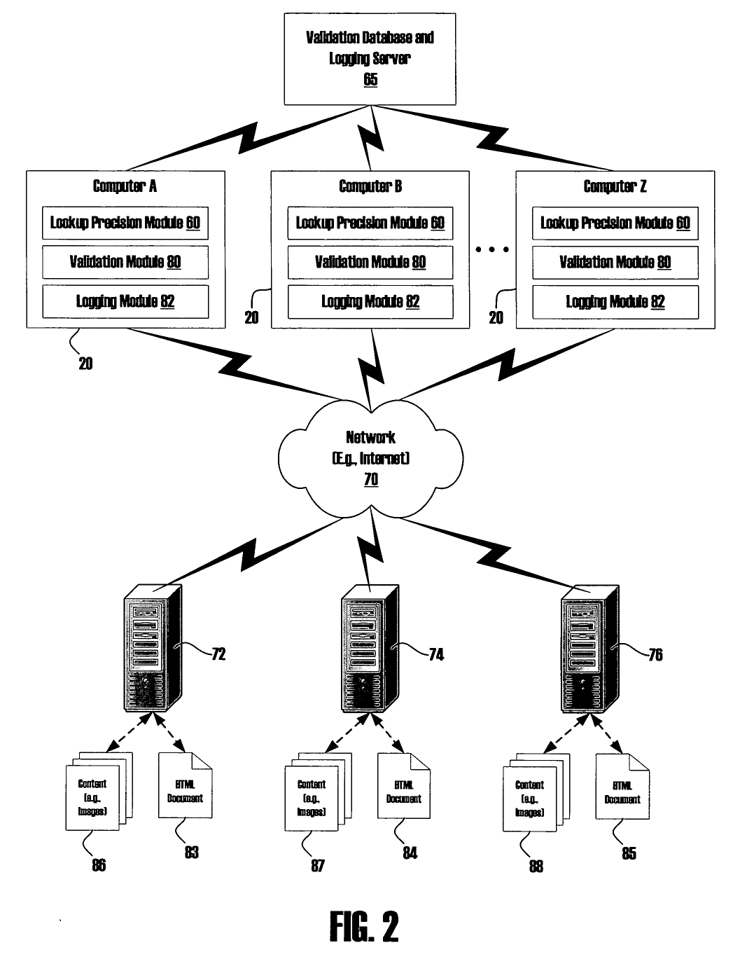

As shown in FIG. 2, a plurality of computers 20 described above with reference to FIG. 1 may be used in a system of the present invention. The computers 20 are in communication with a validation database and logging server 65 and with one or more remote computers 72, 74, 76. The computers 20 communicate with the remote computers 72, 74, 76 via a network 70 such as the Internet to access documents and programs, for instance, Internet web pages. Although not illustrated in FIG. 2, the computers 20 may communicate with the validation database and logging server 65 via one or more hubs or switches. The computers 20 may also communicate with the network 70 via an optional firewall (not illustrated) or other components known to those of ordinary skill in the art.

According to the embodiment of the invention shown in FIG. 2, each computer 20 includes a LookUp Precision Module 60, Validation Module 80, and Logging Module 82. These modules 60, 80, 82 are used in conjunction with the validation database and logging server 65 to track the use of each computer 20 to access designated web sites or specific areas of designated web sites. The modules 60, 80, 82 are also operable to execute filters and scripts that may control the user's use of the Internet browser, as is described in further detail below. As described above with reference to FIG. 1, the LookUp Precision Module 60, Validation Module 80, and Logging Module 82 may be stored on the hard disk, magnetic disk 29, optical disk 31, ROM 24, RAM 25, or other storage element used by the computers 20 to store an a program module or executable code. It should be appreciated that for purposes of brevity the present invention will be described hereinafter with reference to the tracking of the Internet use of a single computer 20, for instance, “Computer A” in FIG. 2. However, as illustrated in FIG. 2, the systems, methods and computer program products of the present invention are operable to track and control the use of multiple computers to access designated web sites or specific areas of designated web sites.

Using the system shown in FIG. 2, a user may use a browser (e.g., Microsoft Corporation's Internet Explorer™) installed on the computer 20 to access documents and programs available on the remote computers 72, 74, 76. Typically, documents residing at the remote computers 72, 74, 76 are HTML documents 83, 84, 85, and may include extensions and enhancements of HTML standards. The documents 83, 84, 85 are used to display associated content 86, 87, 88 on the computer 20, which may include text, images, audio, video, executable software components, etc. The content 86, 87, 88 may be within the HTML documents themselves or incorporated therein by using HTML tags that specify the location of files containing content.

As described in greater detail below, the LookUp Precision Module 60, Validation Module 80, and Logging Module 82 can operate in conjunction with the validation database and logging server 65 to track and log a user's request to view and/or access web pages, such as web pages served by the remote computers 72, 74, 76. Using these system components, the present invention can log information obtained at any point during the user's interaction with his or her web browser. For instance, URLs input or accessed by the user may be logged, along with HTML documents and/or content viewed by a user. Therefore, if a user accesses documents 83, 84, 85 and content 86, 87, 88 from each of the remote computers 72, 74, 76, the present invention can log the identity of the remote computers 72, 74, 76 and store the documents 83, 84, 85 and content 86, 87, 88. The Logging Module 82 can log specific information concerning the user's browsing activity, including the identity of the user and/or computer accessing a web site, the URLs for each web page accessed, the time and duration of access to each site or page (per page time and total time for each page, even if accessed at separate times), the total time a user has used the Internet browser, the navigation history of the user's browser, a client and matter number associated with a browsing session, and the URLs or addresses of any documents or contents viewed by the user, including those of third party sources. Furthermore, the present invention may log all URLs and HTML visited by any open browsers, not just the URL that is currently displayed in the Internet browser's address bar.

Although the tracking features of the present invention permit the tracking of all of a user's Internet activity, the present invention also provides filters that permit an administrator to track only the request or access of specified web sites or portions of specified web sites. This may be advantageous where the use of a particular web site is significant. For instance, certain web sites, such as legal research web sites Westlaw® and Lexis®, charge access fees for their use. The present invention may be used to track the user's use of only such web sites in order to pass the costs of use on to a client. Therefore, the present invention may be implemented as a cost-saving feature.

In addition to tracking Internet browsing, the present invention is operable to control Internet browsing using executable scripts that operate when administrator-specified filters are satisfied. Filters, which are described in greater detail below, may be programmed by an administrator to identify whether a particular web site, or a portion thereof, is significant. For instance, if the administrator is only concerned with the access of a site with the URL “www.fictitious-website.com”, then the filter may be whether or not the user's Internet browser is attempting to access that site or any portion thereof, such as whether the URL requested meets the filter “www.fictitious-website*.*” (where * represents zero or more alphanumeric characters). According to other examples, filters may also be based on the detection of specific key information contained in web page content, such as any web page requiring login information. When filters set up by an administrator are met, scripts may be executed. These scripts may be stored and executed by a scripting module located within the LookUp Precision Module 60. According to an alternative embodiment of the present invention, the scripts and/or scripting module may be stored external to the computer 20, such as in the Validation Database and Logging Server 65. Like the filters, the scripts may be programmed by an administrator to identify what actions should be taken with respect to the user's use of the Internet browser to access a web page.

According to one embodiment of the present invention, filters may execute scripts at four points of time: when the user first accesses a filtered site (“on enter”), before the Internet browser's subsequent navigation (“before navigation”), after a web page loads (“after load”), and upon the exit from a particular site (“on exit”). For instance, after the user enters an administrator-specified URL that meets a particular filter, a script may result in the user being required to enter validation information, such as a billing or client code, prior to permitting the Internet browser to navigate to the requested web page. The validation information required to be entered may be configurable by an administrator, and may include data such as a project number or an employee number. According to other examples, the scripts may cancel the user-requested navigation to the URL or may redirect the browser to a different URL. Scripts, which are considered in greater detail below, may also perform functions after the loading of the requested web page, such as providing data to populate forms on the web page, logging web page information, or the like.

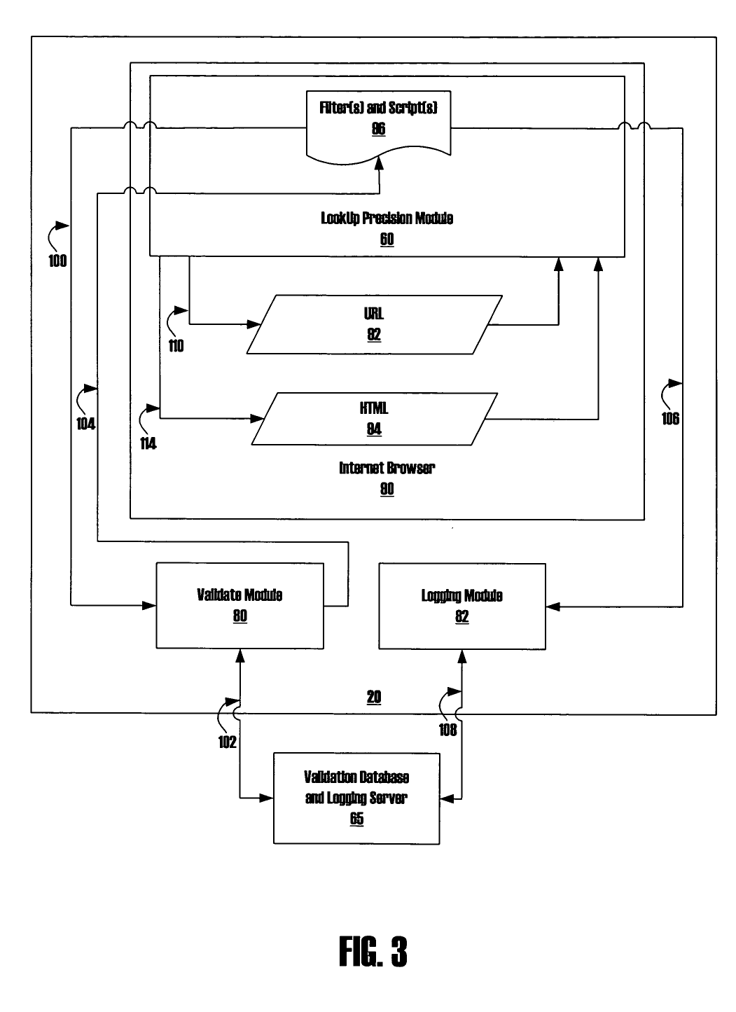

FIG. 3 illustrates how the LookUp Precision Module 60, Validation Module 80, and Logging Module 82 in the computer 20 enable Internet browser tracking and monitoring functions described above. According to a preferred embodiment of the present invention, whenever an Internet browser 90 is opened the LookUp Precision Module 60 is loaded into the Internet browser 90. According to one aspect of the present invention, the LookUp Precision Module 60 may hook into the Internet browser 90 at its startup, such as via a browser helper object where Microsoft's Internet Explorer® is used. The LookUp Precision Module 60 remains active whenever the Internet browser 90 is open in order to track web usage.

Initially, when a user uses the computer's 20 Internet browser 90 to access a particular URL, the LookUp Precision Module 60 requests 110 that the Internet browser 90 provide the requested URL 92 to the LookUp Precision Module 20. Before permitting the Internet browser to access the Internet and navigate to the URL 92, the LookUp Precision Module 20 processes the URL 92 by processing each administrator created filter. The filters are preferably stored local to the LookUp Precision Module 60, though they may alternatively be stored in the validation database and logging server 65 or in another location external to the computer 20. According to one aspect of the invention, each time the browser 90 is started the LookUp Precision Module 20 sends a request to the validation database and logging server 65 to determine if any of the filters 96 have been changed. For instance, this may occur by examining the timestamp associated with a zip file containing the filters. If there are changes, they are transferred to the computer 20. In this manner, a plurality of computers on a network can receive updated filters each time they are used to access the Internet.

Prior to allowing the browser 90 to navigate to a URL, the LookUp Precision Module 20 scans all of the filters to determine if the user-requested URL matches any filter. More specifically, for each filter the LookUp Precision Module 60 compares the filter to the URL 92 to determine if the web site is of interest. The filter is typically a web address that must be matched for a URL to be considered a web site of interest. For example, if a filter is defined as http*://www.aps-soft.com*, where the ‘*’ stands for zero or more alphanumeric characters, the filter will be satisfied when a user enters the URL “http://www.aps-soft.com/products/lookup/index.html”. If the current URL 92 fails to match a filter, the next filter is considered. This process continues until every filter is considered. If a URL fails to match all filters, control is returned to the browser 90 and the browser 90 is permitted to navigate to the user-requested URL. On the other hand, if the current URL matches a filter, the LookUp Precision Module 60 processes the filter. This may occur in succession for each filter condition that is matched by the URL.

Processing a filter includes executing scripts associated with the filter. As previously noted, the scripts are administrator-specified functions that tell the LookUp Precision Module 20 how to handle the user's URL 92 request. According to one aspect of the invention, these scripts have the ability to request 100 that the user provide additional validation information prior to continuing to the user-requested URL. The Validate Module 80, which may also be stored in the computer 20, handles script requests 100 for a user to enter validation information prior to permitting the Internet browser 90 to navigate to the user-requested URL. According to one aspect of the present invention, the Validate Module 80 can communicate with a user interface module (not illustrated) to request and receive user-input validation information. According to another aspect of the present invention, the validate module 80 may provide a GUI that requests the user to input validation information.

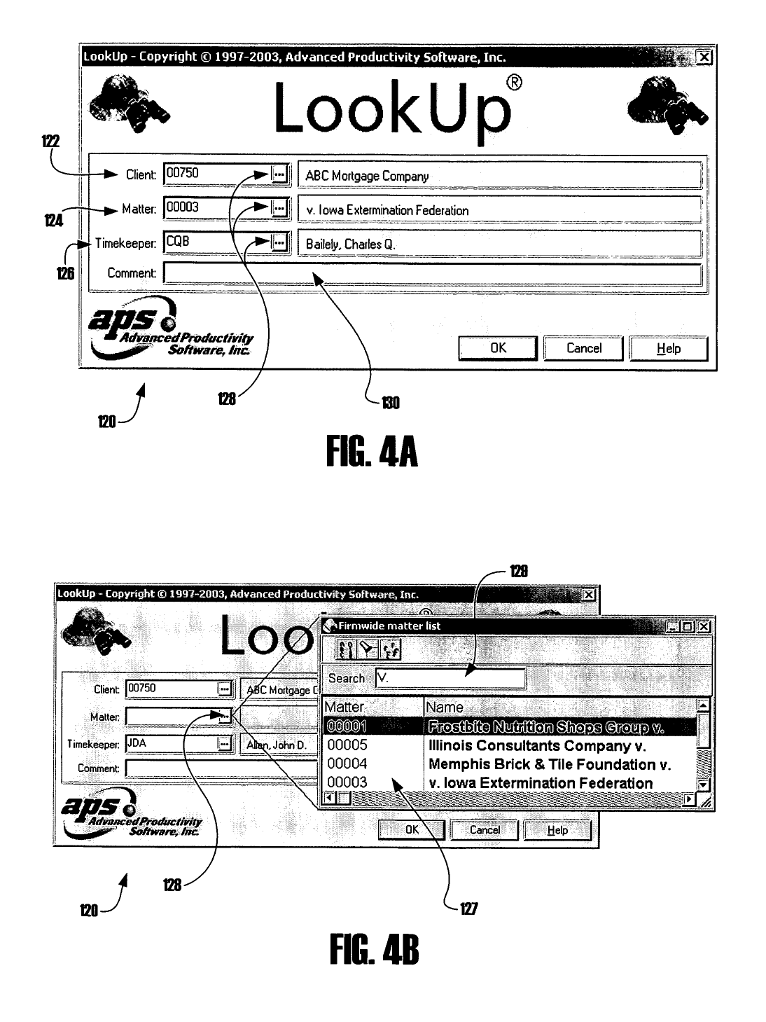

FIG. 4A shows an illustrative validation GUI 120 that may be provided to a user via a pop-up window. The validation GUI includes a client field 122, a matter field 124, a timekeeper field 126, and a comment field 130. These fields receive user-input validation information. The user may toggle between the fields using the “Tab” key or using the mouse, as is well known to those of ordinary skill in the art. After its input the user-input validation information is compared, or validated, by the validate module 80, which may confirm that the user-provided validation information is acceptable by comparing it 102 against validation information stored in the validation database and logging server 65. According to one aspect of the invention, the comment field 130 may receive any user-provided information to describe the browsing session, but is not required and may not be compared against information in the validation database and logging server 65.

As illustrated in FIG. 4A the validation GUI 120 may require validation information to be input by the user in a particular format. For instance, the client and matter fields 122, 124 may each require a 5 digit number, and the timekeeper field 126 may require a three letters. These requirements are set by the administrator. These fields 122, 124, 126 may match up to fields used by the user in other programs. For example, in a law firm these fields 122, 124, 126 may match fields required in a client billing system. According to one aspect of the present invention, the user will be prevented from inputting invalid data in the fields 122, 124, 126. This ensures accurate billing information when the data is eventually logged. Furthermore, once the user saves their valid selections by pressing the OK button, the selections are stored for later use in the script logic, function calls, and most importantly logging. The use of these fields 122, 124, 126 may permit the tracking of Internet use to be integrated with other systems. For instance, where the validation information matches billing information, the user's session may be logged and incorporated into a billing system. This is discussed in greater detail below.

As is shown in the illustrative example of FIG. 4A, some or all of the fields may include a link to aid the user in selecting the appropriate input, such as the ellipsis 128 following the client field 122, matter field 124, and timekeeper field 126. By clicking on or otherwise selecting the ellipsis 128, the user may be provided with a scrolling list and/or search fields that aids the user in selecting the appropriate validation information for a particular field. FIG. 4B shows an illustrative example of a validation lookup window 127 accessed from the validation GUI of FIG. 4A, according to one embodiment of the present invention. As shown in FIG. 4B, if a user clicks on the ellipsis next to the matter field 124, the user may view a list of matters organized in alphabetical order, where the validation information (for instance, a matter number) is shown next to each matter name. This may be provided in a separate pop-up window (e.g., the validation lookup window 127) that includes a search field 129 that enables a user to search by matter name or by matter number. Similar functions may be associated with the ellipsis 128 that correspond to the client field 122 and timekeeper field 126. Because the generation of GUIs are well known to those of ordinary skill in the art, the generation of such GUIs is not considered in further detail herein.

Referring again to FIG. 3, after the user inputs validation information, the Validate Module 80 confirms that the validation information is accurate by comparing 102 the information to acceptable validation information stored in the validation database and logging server 65. The validate module 80 then transmits a validation result 104 to the script requesting the validation procedure. According to one aspect of the invention, the validation result may identify whether the user is validated. According to another aspect of the present invention, the validation result may also contain the user-input information.

Scripts use the results of the validation 104 to control the Internet browser 90. For instance, where the user inputs acceptable validation information, the script may permit the browser to navigate to the user-requested URL. On the other hand, where the user fails to input acceptable validation information, the script may prevent the user from navigating to the user-requested site. Other script functions are possible based on the validation result and/or the specific validation information input by a user. For instance, certain clients may authorize the use of pay-per-use web sites such as Westlaw, whereas others may not. According to one aspect of the invention, scripts may redirect a browser to a particular web page.

Once a web page is loaded, the LookUp Precision Module 60 receives HTML 94, including content, provided by the web page. As noted above, this may be a user-requested URL or a web page a script previously instructed the browser 90 to load. Upon the loading of a web page, scripts may perform additional functions. For instance, scripts may provide data to populate forms on the web page. Scripts may also control what is logged 106 to the validation database and logging server 65 by collecting all information from the URL 92, and any HTML 94 loaded by the Internet browser 90. The script may also log the validation result or user-input validation information, as well as any other information that may be available to the script.

The Logging Module 82 communicates with the validation database and logging server 65. Logged data may be evaluated by an administrator to determine the total amount of use at the specific research sites by the users at the company. FIG. 5 shows the features of the validation database and logging server 65. The server 65 generally includes a database interface module 140 and a validation and log database 148. The database interface module 140 handles the communication 144 between the Validate Module 80 and the validation and log database 148 and the communication 152 between the Logging Module 26 and the validation and log database 148. Because of the database interface module 140, the computer 120 may communicate with the validation and log database 148 using TCP/IP protocol. According to one aspect of the invention, the Database Interface Module 140 may call a logging function passing it a log name and an arbitrary number if data elements as identified by the script. The logging server 65 then places this data in the database table specified. Therefore, the computer 20 does not need layers of SQL drivers to communicate with the database and logging server 65.

According to one aspect of the present invention, communication 144, 152 between the database interface module 140 and the validation and log database 148 are compressed and encrypted for speed and security. The validation and log database 148 contains tables to store accurate validation information. According to the embodiment illustrated in FIG. 5, the validation information includes client, matter, and timekeeper information, each of which may be stored in separate tables. The validation and log database 148 may also contain one or more logging tables. The logging functions of the present invention may log all data into a single table for all Internet web pages. Alternatively, data may be logged into individual tables that correspond to each web site. It should be appreciated by those of ordinary skill in the art that each of the modules and tables are modular and can be executed for a single or multiple networked computers. Therefore, one or more of the above modules and/or tables may be external to the validation database and logging server 65.

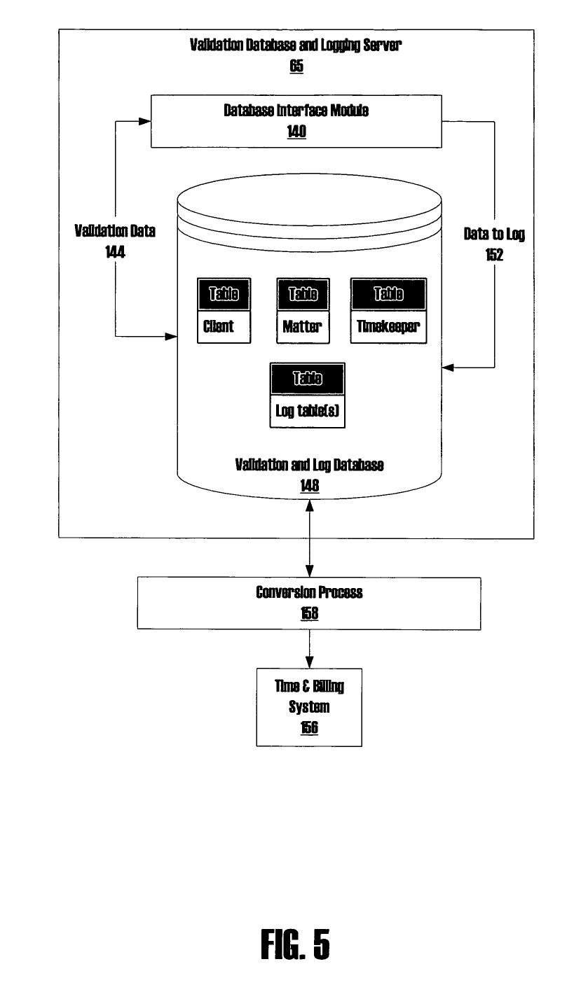

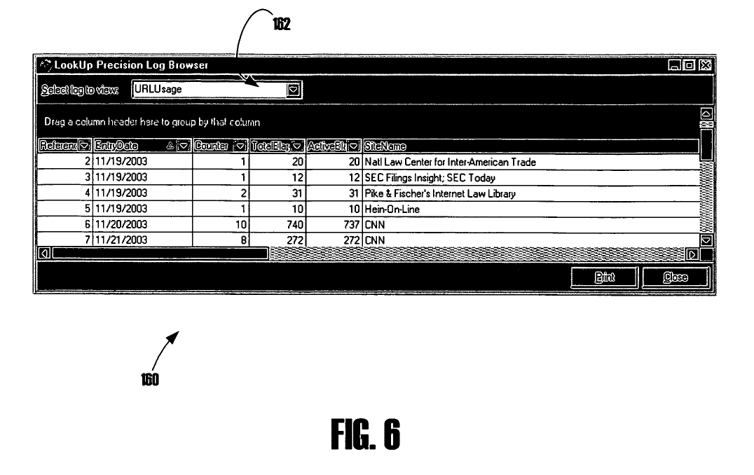

FIG. 6 shows an exemplary log interface 160 illustrating logged web site data. The log data is accessible by a user having administrative rights, and includes data identified by a script for storage. For instance, in the illustrative example shown in FIG. 6, the log interface 160 shows a URLUsage log defined by a script, where the log includes site names, the number of times a page was accessed, the date of access, and the like. According to one aspect of the invention, this interface may be used by an administrator to view any number of logs, where the data fields change based upon their definition as provided in a script.

Referring again to FIG. 5, the validation database and logging server 65 may be in communication with a time & billing system or time tracking software 156, such as the Advanced Productivity Software DTE™ software, which is owned by the assignee of the present invention and is a well known and commercially available time tracking software product. Therefore, the data stored in the validation and log database 148 may be exported to the time & billing system 156. This may occur via a conversion process 158 so that the data may be interpreted by the time & billing system 156. Because many different billing systems may be used in conjunction with the system of the present invention, the data collected by the LookUp Precision Module 60 may have to be converted into a specific format required by the billing system. According to one embodiment of the invention, the conversion process 158 is implemented by a conversion module (not illustrated) that receives each piece of data and processes it so it may be output in a specific format to the billing system. This may require the association of a specific research site and a specific user ID to be matched up with user ids used in the billing system. As such, there may be a credentials log or table that is used to correlate billing system information with information collected by the LookUp Precision Module 60.

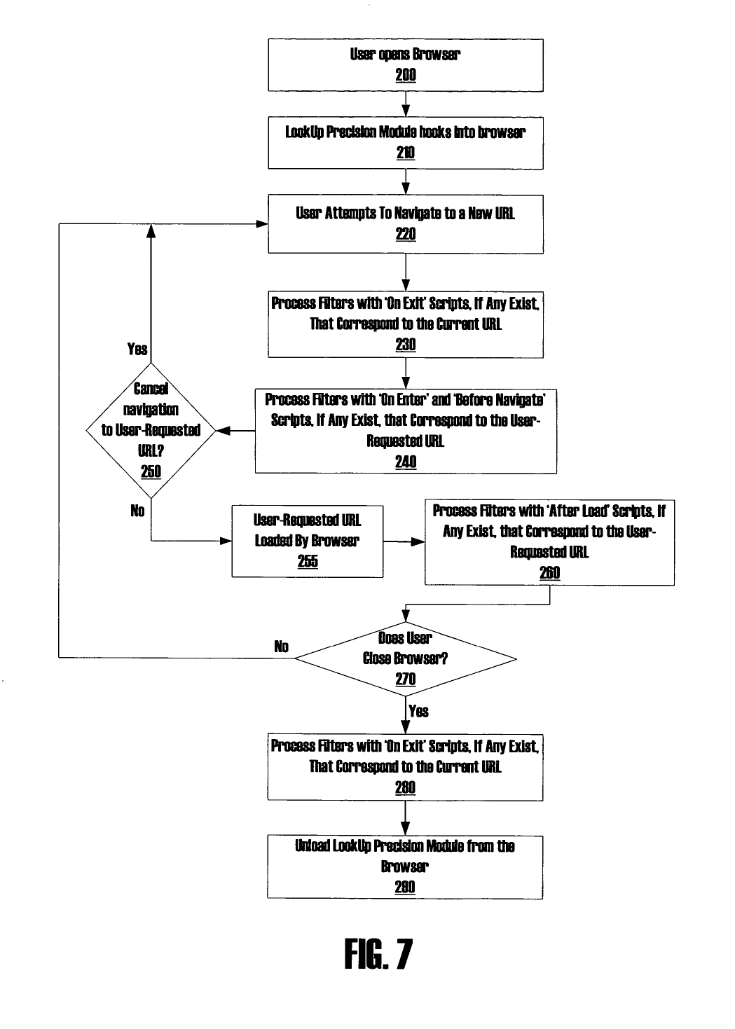

FIG. 7 shows a high level process flow diagram that illustrates the operation of the present invention in processing filters and executing scripts, according to one embodiment of the present invention. Anytime an Internet browser 90 is opened (block 200) the LookUp Precision Module 60 is loaded into the browser (block 210) and remains loaded in order to track a user's Internet use. When user attempts to navigate from a current URL to a new, user-requested URL (block 220) the LookUp Precision Module 60 first processes each filter to determine if any filter conditions are met for the current URL (block 230). This occurs prior to comparing the new, user-requested URL to the filters because one or more filters may execute scripts when a user attempts to exit a page. As noted above, filters may execute scripts in any or all of four circumstances: when the user first accesses a filtered site (“on enter”), before the Internet browser's subsequent navigation (“before navigation”), after a web page loads (“after load”), and upon the exit from a particular site (“on exit”). Scripts for each of the four circumstances may be associated with a single filter. Therefore, for any given URL, the LookUp Precision Module 60 may have to process up to four scripts per filter—when a user inputs the URL, before the browser 90 navigates to the URL, after the web page having the URL loads, and upon a user's attempt to navigate to a new URL. Because filters allow the execution of a script upon the exit from a particular web site, the LookUp Precision Module 60 must initially consider whether an “on exit” script exists for the current URL prior to considering the user-requested URL. As an example, an “on exit” script may generate and display a pop-up window showing the user a total elapsed time the user spent accessing a particular web page.

After processing any filters having “on exit” scripts (block 230), the LookUp Precision Module 60 next processes the filters to determine if any filters are satisfied by the user-requested URL (block 240). Filters may execute scripts immediately after the user enters the user-requested URL (i.e., “on enter”), and/or immediately before the Internet browser 90 navigates to the user-requested web page (“before navigation”). According to one aspect of the invention, the scripts for these filters may instruct the browser to cancel the user-requested navigation (block 250), thereby preventing the user from accessing the user-requested URL. Alternatively, there may either be no filters satisfied by the user-requested URL, or the filters may permit the loading of the user-requested web page after one or more scripts are run. Where no filters are satisfied or applicable scripts allow a web page to load, the LookUp Precision Module 60 permits the user-requested URL to be loaded (block 255). After loading of the user-requested URL, the LookUp Precision Module 60 processes the same filters (i.e., those filters satisfied by the user-requested URL, which are the same as those filters processed in block 240) to determine if any of those filters include “after load” scripts that execute after the loading of a web page (block 260).

This method of processing filters is repeated as the user navigates to more web pages (block 220) until the user closes the browser (block 270). Closing the browser operates like the navigation to a new URL. Therefore, the filters may be processed to determine if any filters having “on exit” scripts are satisfied (block 280). After any such “on exit” scripts are executed, the browser is closed and the LookUp Precision Module 60 is unloaded from the browser 90.

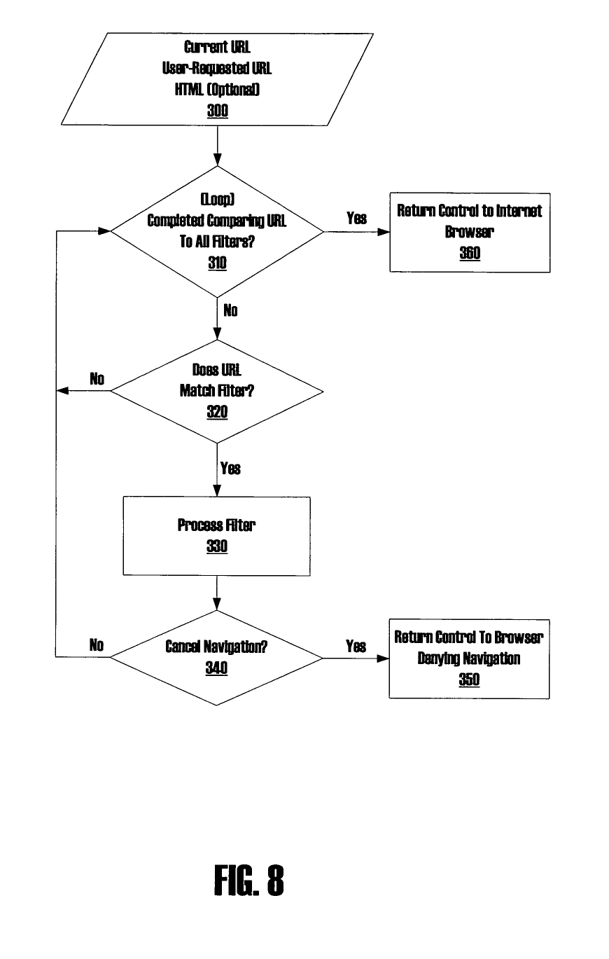

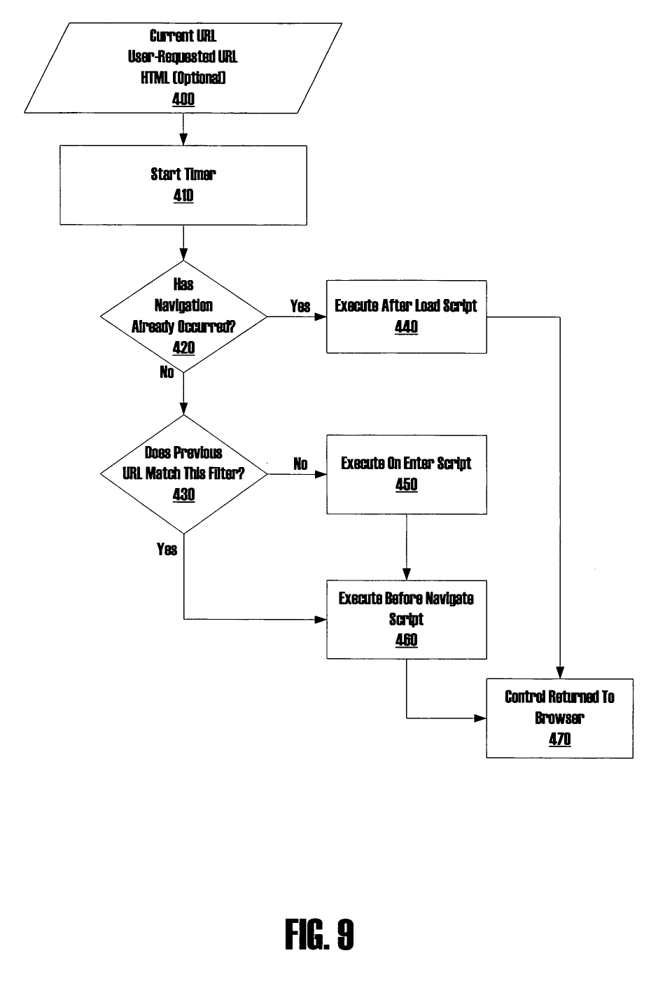

FIG. 8 is a block diagram flow chart illustrating the processing of filters for a URL, according to one embodiment of the present invention. This process may occur in each of blocks 230, 240 and 260 illustrated in FIG. 7. As shown, given a current URL, previous URL, and optionally, HTML 300, the LookUp Precision Module 60 loops through a list of filters to determine web sites of interest 310. For each filter listed the LookUp Precision Module 60 compares the filter's conditions to the current URL to determine a web site of interest (block 320). For each match the LookUp Precision Module 60 processes the filter (block 330). The processing of an individual filter, which may include executing scripts associated with the filter, is described below with respect to FIG. 9. If the filter cancels navigation (block 340) control is returned to the browser denying navigation (block 350). Otherwise, the remaining filters are processed (block 310) before finally returning control to the browser (block 360).

FIG. 9 is a block diagram flow chart illustrating the processing of an individual filter, according to one embodiment of the present invention. This process may occur for each filter during the sequential processing of multiple filters, as occurs in block 330 of FIG. 8. More specifically, given a current URL, previous URL, and optionally, HTML 400, the LookUp Precision Module 60 first starts a timer for the current matching filter (block 410). The timer is used to track the amount of time spent at a particular web site. Next, the LookUp Precision Module 60 determines if the filter is being processed before navigation (block 420). If so, the LookUp Precision Module 60 determines if previous URL also matches this filter (block 430). If not, the LookUp Precision Module 60 executes the ‘On Enter’ script (block 450) since this is the first time the user visits the web site. After executing the ‘On Enter’ script (block 450) or if the previous URL did match (block 430), the LookUp Precision Module 60 executes the ‘Before Navigate’ script (block 460). If the LookUp Precision Module 60 determines that the filter is being processed after navigation (block 420), the ‘After Load’ script is executed (block 440). Finally, control is returned to the browser (block 470).

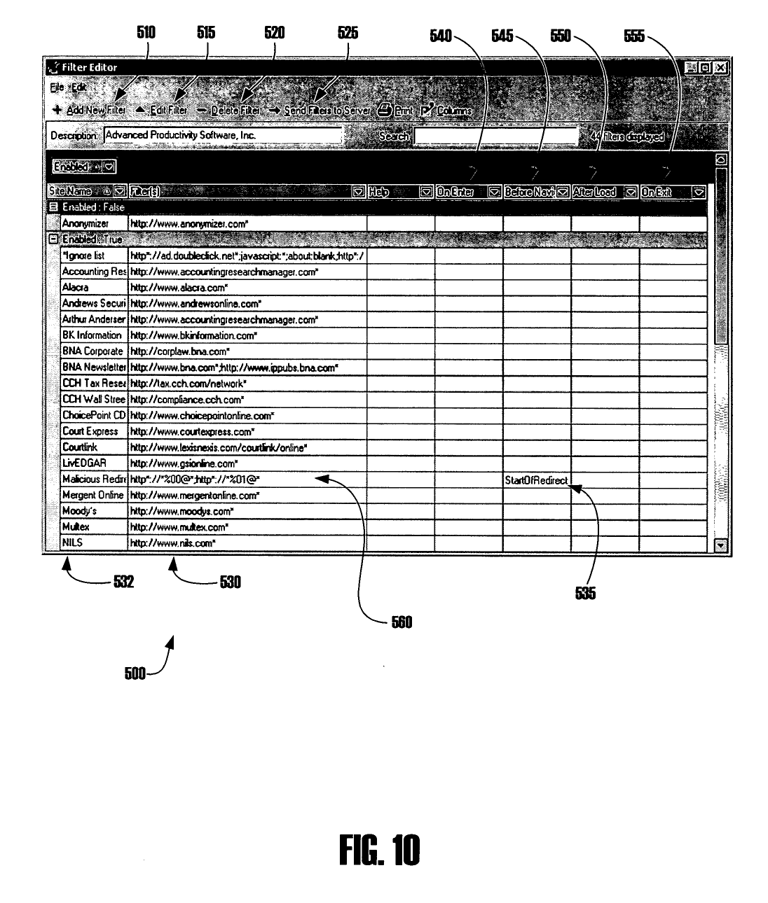

FIG. 10 shows a filter editor 500, according to one embodiment of the invention. The filter editor 500 is a GUI that may be used may an administrator to create and manage filters and scripts. For instance, using the filter editor 500 an administrator may create customizable scripts that are operable to start the validation function, redirect the Internet browser or prevent the loading of a web page, gather the information from the URL and page content, and log information. The filter editor 500 also allows an administrator to view and define web sites of interest that will be logged.

As shown in FIG. 10, the filter editor includes a list of filters 530 along with the common names 532 for each. In the GUI, each filter is provided in its own row directly adjacent to an administrator-defined common name for the filter. Filters are typically web site addresses that may utilize the ‘*’ character to signify zero or more alphanumeric characters. For instance, in the illustrative example of FIG. 10, at least one filter is defined as “http://www.moodys.com*”, which would be satisfied URLs including http://www.moodys.com/cust/help, http://www.moodys.com, http://www.moodys.com/moodys, and the like. Directly adjacent to each filter is an “on enter” field 540, “before navigation” field 545, “after load” field 550, and “on exit” field 555. Each of these fields may include the name of a script that will execute at the time defined by the field 540, 545, 550, 555. For a filter that is satisfied by a current URL or user-requested URL, the “on enter” field 540 identifies the script to be executed immediately when the user first accesses a filtered site (“on enter”); the “before navigation” field 545 identifies the script to be executed immediately before subsequent navigation; the “after load” field 550 identifies the script to be executed immediately after a web page corresponding to a URL is loaded; and the “on exit” field 555 identifies the script to be executed when the user attempts to navigate away from a particular site or attempts to close the Internet browser 90.

The filter editor 500 enables an administrator to add, edit or delete entries from the list of filters 530 using one or more control buttons 510, 515, 520, 525. Therefore, the web sites that are monitored by the present invention are configurable. Additionally, because the scripts are configurable, the information that is logged by the scripts is also customizable. Data logged by the scripts may include a client, matter, and timekeeper information from the validation process, as well as data that is extracted from the web page. Extracted data can even include information like web page page counts or cost per search. The scripts identified by the filter editor 500 also have the ability to redirect the Internet browser based on validation data, the previous URL, and actual web page content. This redirection is useful for sites like Lexis.com and West.com that have the ability to store the validation data on their site for reconciliation by the firm at a later date. Finally, according to one aspect of the invention, the filter editor 500 may be preloaded with a default list of sites and URLs that will be tracked.

According to the illustrative embodiment shown in FIG. 10, the control buttons include an add new filter button 510, an edit filter button 515, a delete filter button 520, and a send filters to server button 525. Generally, the add new filter button 510 is used to create a new filter from scratch, the edit filter button 515 is used to edit a filter shown in the list of filters 530, and the delete filter button 520 is used to delete one or more filters. Furthermore, the send filters to server button 525 may be selected by an administrator to send the current set of filters to the server for automatic distribution to all computers in communication with the validation database and logging server 65. As noted above, the filter update may also occur automatically each time a browser is opened. Other buttons, such as a print button permitting the printing of the filter editor and its contents, and a columns button allowing an administrator to select the columns to show or hide from view, may also be included in the filter editor 500. Additionally, using a mouse one or more additional right-click options, as are well known in the art, may also be included in the filter editor 500, such as a clone filter button and a report generation button.

When the delete filter button 520 is selected, the currently highlighted filter may be deleted, along with its common name and the scripts associated with it. However, where the add new filter button 510 or edit filter button 515 are selected, the LookUp Precision Module 60 will provide the administrator with a detail edit interface, such as the illustrative detail edit interface 600 shown in FIG. 11. The detail edit interface 660 shown in FIG. 11 allows an administrator to enter or edit new filters and to define the scripts to be executed on enter, before navigation, after load, and on exit for a filter.

As illustrated in FIG. 11, filter expressions corresponding to a particular site having an administrator-provided common name 605 may be input in a filter expression window 610. If multiple filters are entered in this window 610 they may be provided in a single cell in the list of filters 530 shown in FIG. 10, where each is separated by a semicolon. The ability to use multiple filter expressions for a particular web site enables an administrator to customize scripts for particular web pages, or portions of specified web pages. The detail edit interface 600 also includes a script entry interface 625 corresponding to each time at which the scripts may execute—on enter, before navigation, after load, and on exit. The detail edit interface 600 includes tabs 620 to identify which script entry interface is currently being viewed and/or edited. The detail interface 600 may also include a definition line 615 that describes the time at which the script shown in the script entry interface 625 executes.

As described in detail above, a script drives what actions should occur when the user accesses a specific URL or HTML. Scripts entered in the script entry interface may utilize certain variable, read-only properties, conditional logic, and pre-established functions. For instance, as illustrated in FIG. 11, one of these variables may be “HTMLContent”, which enables an administrator to utilize a loaded page's HTML content in executing a script. An example of a function may be “MessageDlg”, which allows the administrator to provide the user a pop-up message, which may include buttons for responsive input by a user. Virtually any conditional logic may be supported, and minimal programming is necessary where pre-established functions are provided and known to an administrator.

Scripts may be written using predefined variables, logic, functions and comments. Some variables may be predefined, such as a client number [Client], client name [ClientName], matter number [Matter], Matter Name [MatterName], timekeeper number [Timekeeper], URL [URL], base URL [BaseURL], HTML Content [HTMLContent], time elapsed [ElapsedTime], elapsed seconds at a URL [TotalURLSeconds], etc, where the above-bracketed titles may be used by an administrator to reference a variable. These variables may be used by an administrator to write a script having performing specified functions and logic. For example, read/write commands may enable an administrator to enable navigation to a URL [OK], set a transaction count pertaining to the number of sites visited [TransactionCount], or to set URL redirections [RedirectURL:=URL+Temp], where bracketed items are commands (rather than variables, as in the previous example.) Logic expressions are also enabled to define a script, including if-then conditional statements, URL comparisons, and the like. For instance, an if-then-else conditional statement may be defined using the command [if client <>“0123” then begin . . . ]. An illustrative ‘on enter’ script is provided below in table 1, along with comments (following ‘//’ and presented in italics) explaining the function of each line.

TABLE 1
Illustrative Script

On Enter
// Configurable Settings

// To enable logging total time spent at site set PersistLogTotalTimeAtSite to True; to

disable set to False

PersistLogTotalTimeAtSite := True;
// To increment transaction on the toolbar when logging set

PersistVisibleLogIndication to True; to disable set to False

PersistVisibleLogIndication := True;
// To play sound when logging set PersistAudibleLogIndication to True; to disable

set to False

PersistAudibleLogIndication := False;
// To enable logging of searches set PersistLogTransactions to True; to disable set to

False

PersistLogTransactions := True;

// Required Settings

PersistPacerTimeStamp := ′01/01/1900 12:00:00′; // used to prevent logging multiple

times while retrieving more records

PersistPreviousActiveSeconds := ActiveSeconds;
if PersistLogTotalTimeAtSite then begin

PersistTotalPagesViewed := 0; // used to log total number of pages viewed while at

Pacer

PersistSiteEnterTime := Now;
PersistActiveSecondsSiteEnter := ActiveSeconds;

end;

Briefly, it will be appreciated by those of ordinary skill in the art that the script entry interface 625 can utilize predefined or user-defined variables and executables to effect the control of the browser and the logging of information as described in detail herein. Because the use of variables, logic and functions are known to those of ordinary skill in the art, these will not be discussed further herein. However, the use of such variables, logic and functions in the context of browser control and tracking is unique to the present invention.

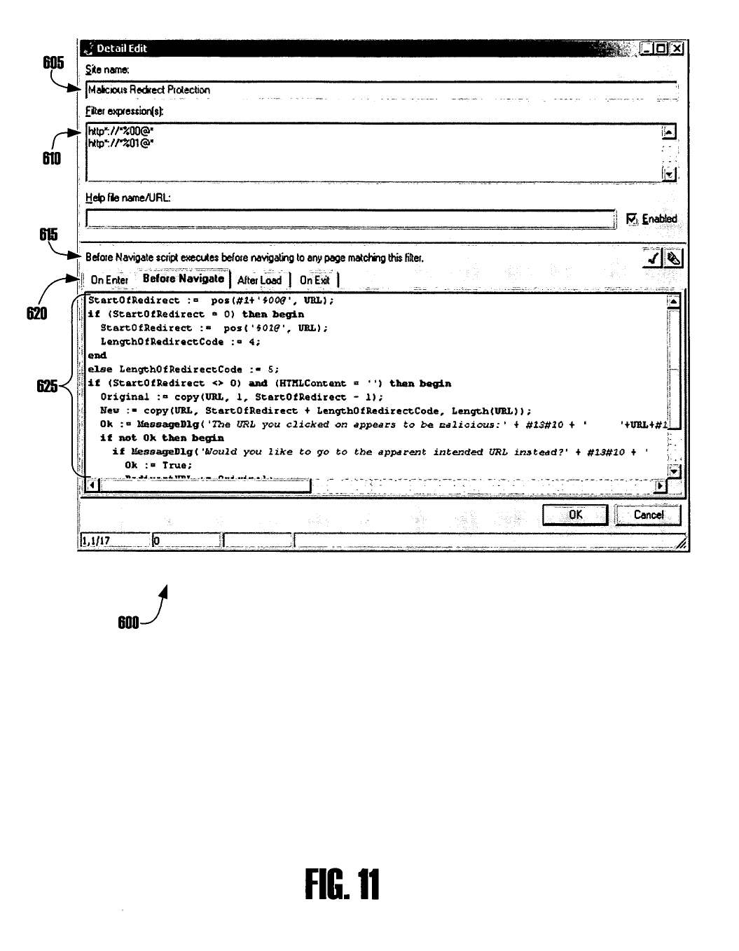

Next, FIG. 12 shows a block diagram flow chart illustrating the handling of a URL that satisfies a filter, such as a user-requested URL. As described in detail above, the current URL, or a user-request URL to target URLs or parts of target URLs within the list of filters 530 to decide if script processing is required. As shown in FIG. 12, if the URL matches a filter having a script executing before navigation (block 700), e.g., “on enter” or “before navigation”, the script may or may not request the user to provide validation information (block 704), such as the validation information described above with respect to FIG. 4. If the script decides that a user should be validated, the validation module is called (block 706), which processes the validation. If the validation is not successful (block 708), control is returned to the browser, but the navigation is canceled (block 710). If the validation is successful (block 708), the script continues with its execution just as if there was no need for validation.

Where validation is not required, or where the validation was successful, the script may redirect the user to a different URL (block 712). If a new URL is used, then the script can assign the current URL to a new URL (block 714). According to one embodiment of the invention, the script may also use any of the information it has collected to determine which data should be logged to text file or database (block 716). This data may include the validation information that the user input or selected using the validation module as well as targeted data from the URL that is deemed important (such as page counts, costs, document names, user ids, elapsed time, etc). As described with respect to FIG. 3, above, some or all of the validation information may also be stored by the validation module in addition to or instead of the script electing to log the information. If logging is needed then the script will call the Logging Module (block 718) and then return control to the browser (block 720). Otherwise, control will be returned to the browser (block 720) without logging information.

As shown in FIG. 12, if the current or user-selected URL matches a filter having a script executing after navigation (block 700), e.g., “after load” or “on exit”, the script may or may not request the user to provide validation information (block 704). Because a web page is loaded, the script may execute to read and fill in fields on one or more forms (block 723). According to one aspect of the invention, user names and/or passwords may be associated with a specific web site, such as a research site. Given as particular web site and a specific user id the user name and password associated with that user may be looked up in a credentials database. This information may then be used to populate fields on a web page. Other functions may be performed, such as notifying users visually or audibly when they have triggered a chargeable or logged event, adding numbers, manipulating data, outputting information to the screen, loading data from a file, and the like. The operations are enabled by the administrator-customizable scripts.

If the script decides that a user should be validated (block 724), the validation module is called (block 726), which processes the validation. If the validation is not successful (block 728), control is returned to the browser, but the navigation is canceled (block 730). If the validation is successful (block 728), the script continues with its execution just as if there was no need for validation. Where validation is not required, or where the validation was successful, the script may redirect the user to a different URL (block 732). If a new URL is used, then the script can assign the current URL to a new URL (block 734). According to one embodiment of the invention, the script may also use any of the information it has collected to determine which data should be logged to text file or database (block 736). This data may include the validation information that the user input or selected using the validation module as well as targeted data from the URL that is deemed important (such as page counts, costs, document names, user ids, elapsed time, etc). As described above, some or all of the validation information may also be stored by the validation module in addition to or instead of the script electing to log the information. If logging is needed then the script will call the Logging Module (block 738).

The Logging Module may be called via a function executed by the script. According to one aspect of the invention, this function can take one or more string variables and post them to a database. The variables contain the information that was collected throughout the browsing process (such as validation data, page counts, costs, document names, user ids, elapsed time, URLs, HTML, etc). This method of logging the detail throughout the browsing experience is preferred because the process of reporting on and billing this information is more detailed as compared to logging an entire session in one large entry at the end of the session. Using the preferred method, the logged information may be processed using validation information, such as client numbers, to generate billable items in a batch process that can be scheduled to execute at regular intervals such at daily, hourly, weekly, and the like. Finally, after logging is complete control will be returned to the browser (block 744) after other functions are performed (block 742). Otherwise, control will be returned to the browser (block 744) after other functions are performed (block 742).

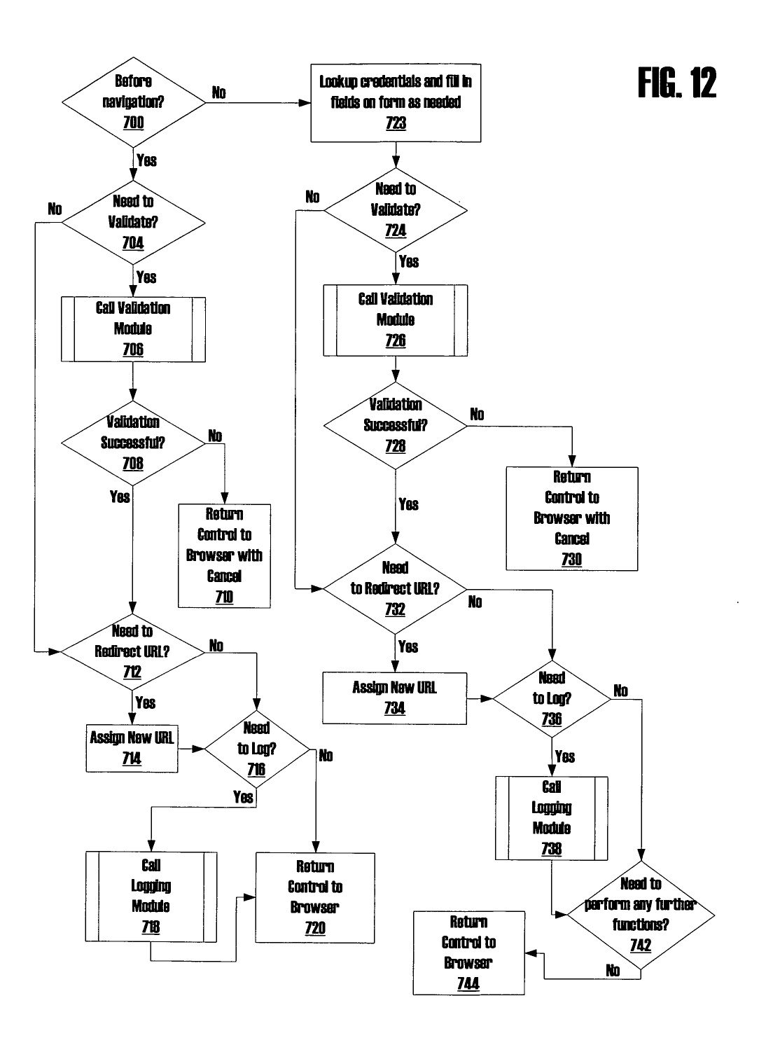

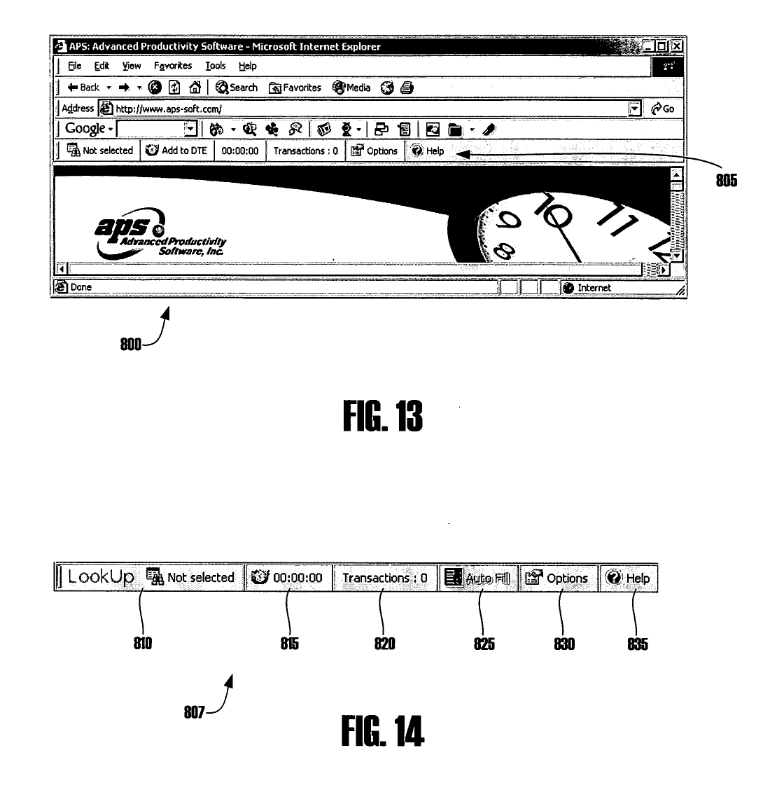

FIG. 13 shows an illustrative web browser 800 having a LookUp Precision toolbar 805, according to one embodiment of the present invention. According to one aspect of the invention, the LookUp Precision Module 60 inserts the toolbar 805 into a web browser to permit a user to control some of the features of the present invention. Therefore, according to one embodiment of the invention, although an administrator may maintain complete control as to what web sites (or portions thereof) are tracked, and the user's ability to use the Internet, the user may also view information pertaining to an Internet browsing session. Another illustrative version of the LookUp Precision toolbar 805 is illustrated in FIG. 14. The toolbar 807 illustrated in FIG. 14 includes a selection button 810, a timer button 815, a transaction button 820, and autofill button 825, an option button 830, and a help button 835.

The selection button 810 allows a user to launch the validation lookup window, such as the validation lookup window 127 illustrated in FIG. 4B. This allows the user to associate client validation information, such as a client name, matter number and comments, to a particular search session. This may be selected at the beginning of a session, or even in the middle of a particular browsing session. Browsing activity associated with a particular client and matter number may be referred to as a browser research session. For instance, immediately before using a pay site, the user may click on the selection button 810 to enter a client and matter number, and the user's timekeeper information, in order to log the browsing research session under the client and matter number. According to one aspect of the present invention, although it is preferred that web sites satisfying administrator-entered filters are the only sites that are monitored, using the selection button 810 a user may also elect to log information for web sites that an administrator chooses not to monitor.

According to one aspect of the present invention, the selection button 810 will read ‘not selected’ where no such information is associated with use of the Internet browser. On the other hand, if a client/matter number is identified, the button may read the client and matter names and/or the client and matter numbers. Additionally, when a new browser is launched from within an existing browser that already contains validation information, the most recently selected validation information may be copied to the new browser and its toolbar.

Next, the timer button 815 is used to show the elapsed time of a browsing research session. According to one embodiment of the present invention, the timer button 815 automatically starts to count in hours, minutes, and seconds upon the access of a new page and continues counting until the URL changes. The timer button 815 may automatically start to count upon entry of the requisite validation information to identify the browsing research session, which may be input by the user after selecting the selection button 810 or input by the user in response to a script requesting validation information. The timer button 815 may display the total elapsed time in which the user has used the Internet browser for a particular browser research session. According to an alternative embodiment of the present invention, the timer may reset after a new page is loaded, although it is preferred that this occurs only when a user is not navigating deeper within a particular web site. Finally, according to one aspect of the invention the timer button 815 may also be configurable by the user by right clicking on the timer. For instance, the timer may be able to started and stopped by the user using a mouse. The button may also be configurable so that the user may right click on the timer or double click on the timer to reset it to zero.

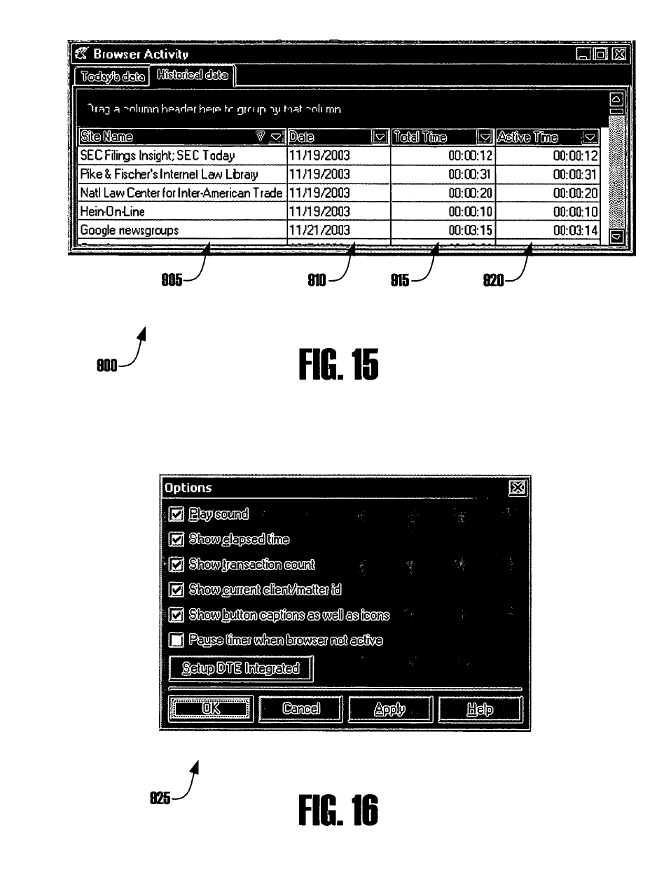

The transaction button 820 allows a user to view a summary of all the sites visited by a user. By clicking on the transaction button 820 a client may view a log of a user's online browsing session for the current day or historical data related to past research. An illustrative browser activity log that is displayed upon the selection of the transaction button 820 is shown in FIG. 15. The browser activity log 900 displays both web browsing data for the current day and historical data. This data includes site name 905, date 910, total time 915 and active time 920 fields. The site name field 905 identifies the name of the web site that was accessed. According to one aspect of the invention, the name of the web site is the administrator-defined common name associated with the visited site, where the visited site satisfies the filter associated with the administrator-defined common name. The date field 910 indicates the date on which the web site was accessed. The total time field 915 identifies the amount of time that the web site was displayed in a user's web browser. The active time displays the amount of time that the web browser was active while the web site was displayed. Because the present invention can account for only that time in which a browser is active, the present invention will not account for time in which other programs or windows in focus are being used. This also allows a user to utilize multiple browsers simultaneously without accumulating total time for both windows simultaneously. Although not illustrated in the browser activity log 900, a client and matter number, or other validation information input by the user during a browser research session in which a site is accessed, may also be displayed by the browser activity log 900. This permits a user to view and distinguish all web activity for all browser research sessions.

According to one aspect of the invention, by right clicking on the browser activity log 900, a user may choose to print the log. The user can also configure the log to list information based on site name, date, total time, or active time by clicking on the respective headings. Changing the order of in which one of the columns displays information may also change the information shown in each row to maintain the relationship between a row of data, as is well known in the art. The user can therefore organize the log prior to printing.

Referring again to the toolbar 807 illustrated in FIG. 14, the autofill button 825 may permit a user to automatically fill in fields on web pages with data that the script has access to. According to one aspect of the invention, this could be validation information such as a client or matter number, and/or username and password information. The scripts may specify the data used to fill in fields, or the data may come from a database such as the credential database described above. Because the HTML for pages in which fields are to be filled is known, the present invention can identify and fill in the fields with the specified data, as is known in the art.

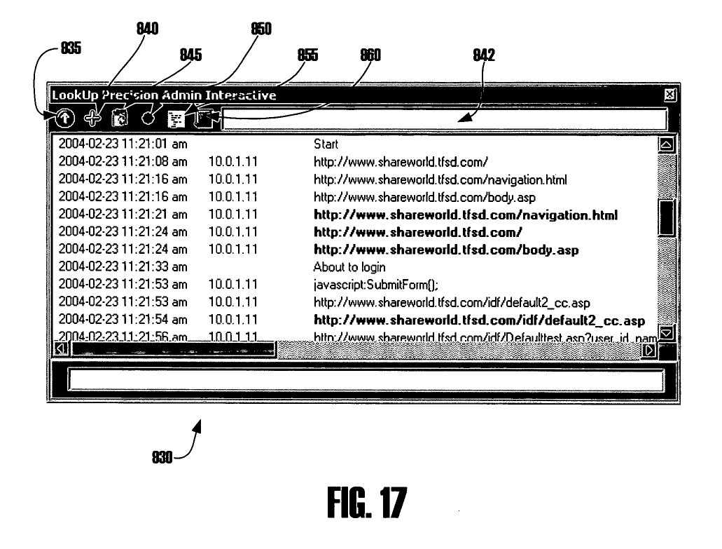

The toolbar 807 also includes an options button 830 that opens the option interface 925 shown in FIG. 16. More specifically, the options interface 925 may be used by a user to customize the toolbar 807. In the illustrative example shown in FIG. 16, the options interface 925 includes numerous checkable boxes that permit a user to show/hide items, turn sound on/off, show a transaction count, show current client/matter id, show button captions as well as icons, and pause the timer when the browser is not active and other configuration options. To activate an option, a user may click in the checkbox associated with the option so that a check appears. To de-activate an option, a user may click in the checkbox so the check disappears. Clicking the OK button saves the options and closes the options interface 925.

The play sound option may identify when a transaction is being logged to the validation database and logging server 65, for instance, by playing a sound. The show elapsed time option allows a user to instruct the toolbar 807 to display the elapsed time associated with the client/matter research session. Likewise, the show transaction count may be selected by the user to instruct the toolbar 807 to display the number of transactions that have occurred during the browser research session. The show current client/matter id option enables the toolbar 807 to display the current client/matter that is associated with the browser research session.

Finally, the help button 835 may direct the user to a help interface instructing the user how to use some or all of the features described in the present application. According to one aspect of the present invention, the help button 835 on the toolbar 807 may also provide customized, site-specific help for the web site the user is accessing. This customized help may be provided by an administrator using one or more interfaces. For instance, the help can be used to provide tips on how to best use a research site or provide information regarding Internet research policies.

FIG. 17 shows an illustrative administrative interface 930, according to one embodiment of the present invention. Briefly, the administrative interface 930 is operable to show activity of all open browsers. As such, the interface 930 facilitates the creation, modification, and testing of filters. For instance, after determining that many open browsers utilize a particular pay-per-use web site, an administrator may decide to add the web site to the list of filters and to request validation information before permitting a user to access the site.

As shown in FIG. 17, the interface 930 includes a URL log that includes rows of information including a date/timestamp for an action (e.g., loading a web site, exiting a web site, etc.), the address for the user computer performing the action, and the URL and HTML visited by an open browser. Using the interface 930 an administrator may view all the actual URLs and HTML visited by any open browsers, not just URLs that are displayed in the Address Bar. Using the interface 930 an administrator has the ability to: show or hide visited & time stamped URLs, clear contents, add a comment to the visited URL/HTML log, mark the start of a chargeable page in the visited URL log, mark the end of a chargeable page in the visited URL log, edit a script, and view the HTML contents.

The interface 930 includes numerous buttons 935, 940, 945, 950, 955 that enable an administrator to view browsing activity and configure the LookUp Precision Module. According to one aspect of the invention, one or more of these buttons may operate in conjunction with a highlighted URL log row selected by the administrator, e.g., using a mouse. First, the show/hide button 935 will collapse and un-collapse the URL log window, showing only the buttons at the top of the interface 930. The add comment button 940 allows the administrator to add text to the URL log, where the text added to the URL log window is text that is input by the administrator in a text window 942 at the top of the interface 930. This text is inserted into the URL log with a time stamp showing the time at which it was added to the log. Next, the clear contents button 945 allows the administrator to clear the contents of the URL log. The chargeable page button 950 adds the phrase “start of chargeable page” to the contents of the URL log. The text will be preceded by a date/time stamp and the contents of the textbox. Next, the script edit button 955 provides that administrator with a detail edit interface, such as the detail interface of FIG. 11, that is associated with the currently highlighted web page. Finally, the HTML content button 960 may display the contents of the HTML for a highlighted row, where the HTML content is available.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for controlling an Internet browser, comprising:
storing at least one filter, wherein the at least one filter corresponds to one or more Internet web addresses;
identifying a uniform resource locator (URL) requested by the Internet browser;
comparing the requested URL to the at least one filter to determine whether the requested URL matches the one or more Internet web addresses; and
executing a script when the requested URL matches the one or more Internet web addresses corresponding to the at least one filter.

2. The method of claim 1, wherein the step of executing a script further comprises the step of executing a user-defined script associated with the at least one filter.

3. The method of claim 2, further comprising the step of presenting a script edit interface to a user, wherein the script edit interface is operable to enable a user to define the user-defined script.

4. The method of claim 3, further comprising the step of receiving a user-defined executable instruction via the script edit interface.

5. The method of claim 3, wherein the step of presenting the script interface comprises presenting the script interface to a user only if the user has administrative rights.

6. The method of claim 2, further comprising the step of presenting at least one filter edit interface to the user, wherein the filter edit interface is operable to receive the at least one filter from the user.

7. The method of claim 6, further comprising the step of receiving the at least one filter from the user only if the user has administrative rights.

8. The method of claim 1, wherein the step of executing the script further comprises the step of preventing the Internet browser from navigating to the web site having the URL requested by the Internet browser.

9. The method of claim 1, wherein the step of executing the script further comprises the step of requesting validation information from a user prior to permitting the Internet browser from navigating to the web site having the URL requested by the Internet browser.

10. The method of claim 9, wherein the step of requesting validation information from a user comprises requesting validation information selected from the group of information consisting of a user ID, a client number, a client name, a matter name, and a matter number.

11. The method of claim 9, further comprising the step of presenting the user a validation interface, wherein the validation interface is operable to receive validation information input by a user.

12. The method of claim 11, further comprising the step of displaying validation information stored in a time entry program.

13. The method of claim 1, further comprising the step of identifying a current uniform resource locator (URL) currently displayed by the Internet browser.

14. The method of claim 13, further comprising the step of comparing the current URL to the at least one filter to determine whether the current URL matches the one or more Internet web addresses.

15. The method of claim 14, further comprising the step of executing a script when the current URL matches the one or more Internet web addresses.

16. The method of claim 15, wherein the step of executing the script when the current URL matches the one or more Internet web addresses occurs prior to executing a script when the requested URL matches the one or more Internet web addresses corresponding to the at least one filter.

17. The method of claim 1, further comprising the step of logging the requested URLs that match the one or more Internet web addresses corresponding to the at least one filter.

18. The method of claim 1, wherein the step of executing a script occurs before the Internet browser navigates to the one or more Internet web addresses that match the requested URL.

19. The method of claim 1, wherein the step of executing a script occurs immediately after the Internet browser navigates to the one or more Internet web addresses that match the requested URL.

20. The method of claim 1, wherein the step of executing a script occurs immediately after the Internet browser loads the one or more Internet web addresses that match the requested URL.

21. A method for controlling an Internet browser, comprising:
storing at least one filter, wherein the at least one filter corresponds to one or more predefined Internet web addresses;
identifying a uniform resource locator (URL) for the Internet web page currently displayed by Internet browser;
comparing the URL to the at least one filter to determine whether the URL matches the one or more predefined Internet web addresses; and
executing a script when the URL matches the one or more predefined Internet web addresses corresponding to the at least one filter.

22. The method of claim 21, wherein the step of executing a script occurs immediately upon exit from the Internet web page currently displayed by the Internet browser.

23. The method of claim 21, wherein the step of executing a script further comprises the step of executing a user-defined script associated with the at least one filter.

24. The method of claim 23, further comprising the step of presenting a script edit interface to a user, wherein the script edit interface is operable to enable a user to define the user-defined script.

25. The method of claim 24, further comprising the step of receiving a user-defined executable instruction via the script edit interface.

26. The method of claim 24, wherein the step of presenting the script interface comprises presenting the script interface to a user only if the user has administrative rights.

27. The method of claim 23, further comprising the step of presenting at least one filter edit interface to the user, wherein the filter edit interface is operable to receive the at least one filter from the user.

28. The method of claim 27, further comprising the step of receiving the at least one filter from the user only if the user has administrative rights.

29. The method of claim 21, wherein the step of executing the script further comprises the step of preventing the Internet browser from navigating to a user-requested web site.

30. The method of claim 21, wherein the step of executing the script further comprises the step of requesting validation information from a user prior to permitting the Internet browser from navigating to a user-requested web site.

31. The method of claim 30, wherein the step of requesting validation information from a user comprises requesting validation information selected from the group of information consisting of a user ID, a client number, a client name, a matter name, and a matter number.

32. The method of claim 30, further comprising the step of presenting the user a validation interface, wherein the validation interface is operable to receive validation information input by a user.

33. The method of claim 32, further comprising the step of displaying validation information stored in a time entry program.

34. The method of claim 21, further comprising the step of identifying a requested URL requested by the Internet browser.

35. The method of claim 34, further comprising the step of comparing the requested URL to the at least one filter to determine whether the requested URL matches the one or more Internet web addresses.

36. The method of claim 35, further comprising the step of executing a script when the requested URL matches the one or more Internet web addresses.

37. A system for controlling Internet browsing, comprising:
a computer, wherein the computer includes an Internet browser operable to display an Internet web site and to receive a user request to navigate to a requested uniform resource locator (URL); and
a lookup precision module in communication with the computer, wherein the lookup precision module is operable to:
identify the requested URL;
compare the requested URL to at least one filter to determine whether the requested URL matches one or more Internet web addresses corresponding to the at least one filter; and
execute a script when the requested URL matches the one or more Internet web addresses corresponding to the at least one filter.

38. The system of claim 37, wherein the lookup precision module is local to the computer.

39. The system of claim 37, wherein at least a portion of the lookup precision module is remote from the computer.

40. The system of claim 37, further comprising a script edit interface in communication with the lookup precision module, wherein the script edit interface allows an administrator to define the script.

41. The system of claim 40, wherein the script edit interface is operable to receive a user-defined executable instruction.

42. The system of claim 37, wherein the script contains a URL redirection instruction such that the Internet browser will navigate to a new URL instead of the requested URL.

43. The system of claim 37, wherein the script contains a validation request instruction such that the user will be requested to input validation information prior to the Internet browser navigating to the requested URL.

44. The system of claim 43, further comprising a validation module in communication with the lookup precision module, wherein the validation module is operable to validate validation information input by the user.

45. The system of claim 44, wherein the validation module is in communication with a time entry program.

46. The system of claim 44, wherein the validation module is in communication with a billing system.

47. The system of claim 37, further comprising a filter edit interface, where the filter edit interface is operable to receive the at least one filter from the user.

48. The system of claim 37, further comprising at least one database in communication with the lookup precision module, wherein the database is operable to store historical browsing activity of the Internet browser.

49. A computer-readable medium storing computer-executable instructions for performing the steps of:
identifying a uniform resource locator (URL) requested by an Internet browser;
comparing the requested URL to at least one filter identifying at least one Internet address to determine whether the requested URL matches the at least one Internet address; and
executing a script when the requested URL matches the one or more Internet web addresses corresponding to the at least one filter.

50. The computer-readable medium of claim 49, wherein the computer-readable medium further stores computer-executable instructions for presenting a script edit interface to a user, wherein the script edit interface is operable to enable a user to define the user-defined script.

51. The computer-readable medium of claim 50, wherein the computer-readable medium further stores computer-executable instructions for receiving a user-defined executable instruction via the script edit interface.

52. The computer-readable medium of claim 50, wherein the computer-readable medium further stores computer-executable instructions for presenting the script interface to a user only if the user has administrative rights.

53. The computer-readable medium of claim 49, wherein the computer-readable medium further stores computer-executable instructions for presenting at least one filter edit interface to the user, wherein the filter edit interface is operable to receive the at least one filter from the user.

54. The computer-readable medium of claim 49, wherein the computer-readable medium further stores computer-executable instructions for preventing the Internet browser from navigating to a web site having the URL requested by the Internet browser.

55. The computer-readable medium of claim 49, wherein the computer-readable medium further stores computer-executable instructions for requesting validation information from a user prior to permitting the Internet browser from navigating to a web site having the URL requested by the Internet browser.

56. The computer-readable medium of claim 55, wherein the computer-readable medium further stores computer-executable instructions for requesting validation information selected from the group of information consisting of a user ID, a client number, a client name, a matter name, and a matter number.

57. The computer-readable medium of claim 55, wherein the computer-readable medium further stores computer-executable instructions for accessing validation information stored in a time entry program.

58. The computer-readable medium of claim 49, wherein the computer-readable medium further stores computer-executable instructions for identifying a current URL currently displayed by the Internet browser.

59. The computer-readable medium of claim 58, wherein the computer-readable medium further stores computer-executable instructions for comparing the current URL to the at least one filter to determine whether the current URL matches the at least one Internet addresses.

60. The computer-readable medium of claim 59, wherein the computer-readable medium further stores computer-executable instructions for executing a second script when the current URL matches the one or more Internet web addresses.
